(19) United States
(12) Patent Application Publication
(10) Pub. No.: US 2004/0119728 A1
(43) Pub. Date: Jun. 24, 2004

(54) User programmable overlay facility for use with video display

(75) Inventors: Jessica Marie Blanco, Austin, TX (US); Jeffrey Allen Jones, Round Rock, TX (US); Scott Thomas Jones, Austin, TX (US); Sharon Pagapong Laquinta, Austin, TX (US)

Correspondence Address: LALLY & LALLY LLP, PO BOX 684749, AUSTIN, TX, 78768-4749, US

(73) Assignee: International Business Machines Corporation, Armonk, NY

(21) Appl. No.: 10/327,171

(22) Filed: Dec. 20, 2002

(51) Int. Cl. G09G 5/00

(52) U.S. Cl. 345/629

(57) ABSTRACT

A display system includes a display device that receives a video signal via a first port and user programmable overlay information via a second port. The display device includes overlay code for generating an overlay image derived from the overlay information and for simultaneously displaying a video image derived from the video signal and the overlay image on the display screen. The system further includes an overlay information source device having user I/O and means enabling a user to define the overlay information using the I/O means. An output port of the source device conveys the overlay information to the second port of the display device. The overlay information may include attribute information such as position information, transparency information, and color information. The overlay code applies the corresponding attributes to the overlay image. The port over which the overlay information is conveyed may be a USB port or a Bluetooth port.

### BACKGROUND

1. Field of the Present Invention

The present invention generally relates to the field of video display devices and more particularly to video display devices that include overlay facilities for presenting overlay information.

2. History of Related Art

Video display devices, including computer monitors, television sets, and a host of other devices are designed to receive a signal containing video content and to convert the information in the signal to an image or sequence of images. The video content signal may be a digital or analog signal. In the case of a microprocessor-based computer, for example, a video adapter typically generates digital video display information in a suitable format (RGB, for example) based on commands or data the adapter receives from the microprocessor. The video display receives the video display information and converts the information to an image on the display device. In other cases such as conventional cable or broadcast television, the video content signal may be an analog signal that is converted to an image or image sequence by the display device (i.e., the television).

Regardless of the video signal type or format, it is generally impractical for an end-user of the display device to alter or supplement the video signal content with the goal of adding user specified information to the display. If, for example, a user wanted to overlay a particular graphical image (such as a logo) or text string “on top” of a television signal image, it would not generally be practical for the user to alter the television signal provided via the television's antenna or cable to include the desired information. In various applications and contexts, however, it may be desirable to display user defined information simultaneously with the video signal information. For purposes of this disclosure, “user defined information” refers to information that is not contained in the video signal as the video signal is received from the video signal source, whether the video signal source is a graphics adapter, wireless transmitter, etc. It would be desirable to implement a system and method that enabled users to specify overlay information that would then be displayed on a display device.

### SUMMARY OF THE INVENTION

The problems identified above are in large part addressed by a display system, its components, and methods of use, for enabling users to define information that supplements or alters the image being displayed on a display device. The display system includes a display device that receives a video signal via a first port and receives user programmable overlay information via a second port. The display device includes overlay code for generating an overlay image derived from the overlay information and for simultaneously displaying a video image derived from the video signal and the overlay image on the display screen. The system further includes an overlay information source device having user I/O and means enabling a user to define the overlay information using the I/O means. An output port of the source device conveys the overlay information to the second port of the display device. The overlay information may include attribute information such as position information, transparency information, and color information. The overlay code applies the corresponding attributes to the overlay image. The port over which the overlay information is conveyed may be a USB port, a FireWire® port, or a Bluetooth™ port. FireWire® (IEEE 1394) is a registered trademark of Apple Computer. Bluetooth™ is a trademark of Bluetooth SIG, Inc.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a display system according to one embodiment of the invention;

FIG. 2 is a block diagram of selected elements of an embodiment of a display device suitable for use in the system of FIG. 1;

FIG. 3 is a conceptual representation of a storage or memory configuration of the display device of FIG. 2 according to one embodiment of the invention;

FIG. 4 is a block diagram of selected elements of an overlay device suitable for use with the system of FIG. 1; and

FIG. 5 conceptually illustrates a relationship between an exemplary storage element in the display device of FIG. 2 and pixels in the display device itself according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a system and its component devices that facilitate or enable user-defined display information in conjunction with a graphical display device. The user defined information is provided to the display device via a “sideband” signal meaning a signal distinct from and independent of the video signal received by the display device. The display device would likely include an overlay plane implemented with some form of persistent storage to contain the user specified information. The display device is configured to display the information contained in the overlay plane as well as the information in the video signal thereby enabling the display system user to display messages, logos, or other information in parallel with the video signal content. The system preferably leverages facilities existing within many modern display systems to reduce implementation cost and complexity. These leveraged facilities may include on-screen display facilities used to display device configuration menus and USB, FireWire®, or Bluetooth™ ports that are becoming increasingly prevalent on many displays.

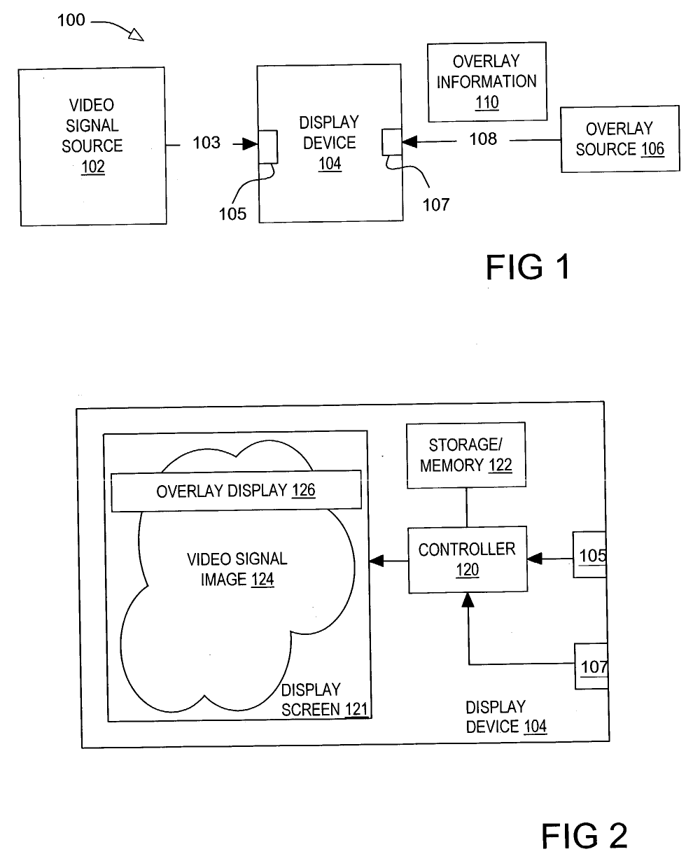

Turning now to the drawings, FIG. 1 is a block diagram of selected elements of a display system 100 according to one embodiment of the present invention. In the depicted embodiment, display system 100 includes a video signal source 102 and an overlay information source (overlay source) 106 connected to a display device 104. Display device 104 may include substantially all the elements of a conventional computer display monitor or television set. Overlay source 106 is shown as generating information identified as overlay information 110 to display device 104.

Video signal source 102 represents the provider of the video signal that display device 104 receives and from which display device 104 generates the displayed video image. In the case of a digital video signal, video signal source 102 may represent a conventional microprocessor-based data processing device such as a network server, desktop or laptop personal computer, a network computer, and the like. In such an environment, video signal source 102 may be more specifically represented by a video graphics adapter within the system. In the case of an analog video signal, video signal source 102 may represent a wireless transmitter such as a broadcast television signal or a cable television service provider.

In the depicted embodiment, video signal source 102 provides the video signal to display device 104 via a first connection (video connection) 103 to a first port (video port) 105 of display device 104. Overlay source 106 is shown as providing overlay information 110 to display device 104 via a second connection (overlay connection) 108 to a second port (overlay port) 107. In the context of the present invention, these connections 103 and 105 represent wires, cables, signal busses, or wireless frequencies as the case may be.

In an embodiment suitable for use with a data processing system (computer) video signal source 102, video connection 103 is likely a standard RGB-type cable and video port 105 is a standard VGA port of the computer. In other cases, video connection 103 may represent a VHF or UHF signal formatted according to one of the various television signal formatting conventions including the National Television Standards Committee (NTSC) format used in the U.S. and the SECAM (Système Electronique pour Couleur Avec Memoire) and PAL (Phase Alternating Line) formats used in various parts of Europe while video port 105 may represent the television's cable or antenna port.

In the preferred embodiment of the invention, as depicted in FIG. 1, overlay source 106 provides overlay information 110 to display device 104 over a connection that is distinct from and independent of video connection 103. In an embodiment that beneficially leverages facilities that may be found on conventional display devices, overlay port 107 represents an external USB (Universal Serial Bus) port, a FireWire® port, or a Bluetooth™ port. Some or all of these types of ports are being provided on many modern display monitors and television sets. In this sense, the overlay connection 108 is referred to herein as a sideband connection or sideband signal with respect to video connection 103. The ability to provide overlay information 110 to display device 104 over a sideband connection beneficially renders any modification of the video signal unnecessary. Instead of achieving overlay information on the display device by performing potentially complex manipulation of the video signal, the overlay information is delivered without regard to the content and timing of the video signal. The use of a standardized and commonly encountered port for receiving the overlay information beneficially extends the number of display devices on which the facilities of the present invention may be implemented without substantially increasing the display device's cost or configuration.

Turning now to FIG. 2, a block diagram of selected elements of display device 104 according to one embodiment of the invention is depicted. In the depicted embodiment, display device 104 includes an embedded or general purpose controller 120 configured to communicate with video port 105 and overlay port 107. Memory and/or storage 122 are accessible to controller 120 and may contain instructions executable by the controller to carry out the information overlay features of the invention. Portions of memory/storage 122 may be integrated into controller 120 while other portions may be external. Portions of memory/storage 122 may be randomly accessible and volatile memory (DRAM or SRAM) while other portions may be implemented with non-volatile or persistent storage such as flash memory devices and other electrically alterable devices. Controller 120 is configured to receive the video signal via video port 105 and overlay information 110 (FIG. 1) via overlay port 107. Based on the video signal and the overlay information, controller 120 generates an image on display screen 121 that includes an overlay display 126 derived from overlay information 110 and a video display image 124 derived from the video signal. Overlay display 126 is likely to be superimposed over the video display image 124.

Overlay display 126 preferably includes or consists of user-defined information such as a user-defined text string, logo, or combination of both. Depending upon the amount of resources dedicated to the overlay facility, overlay display 126 may include user-alterable attributes such as transparency, position, and so forth. It is contemplated that implementation of a user-defined overlay feature as disclosed may be aided by the existence of facilities in some conventional display devices used to achieve configuration menus and the like. In display devices that have these facilities, configuration menus appear superimposed over the video display image when the user pushes a button on the display device or on a remote control device. The present invention contemplates an extension of these facilities to encompass user defined functionality. In addition, the amount of memory dedicated to the overlay mechanism of the present invention is likely greater than the memory dedicated to the existing configuration menus.

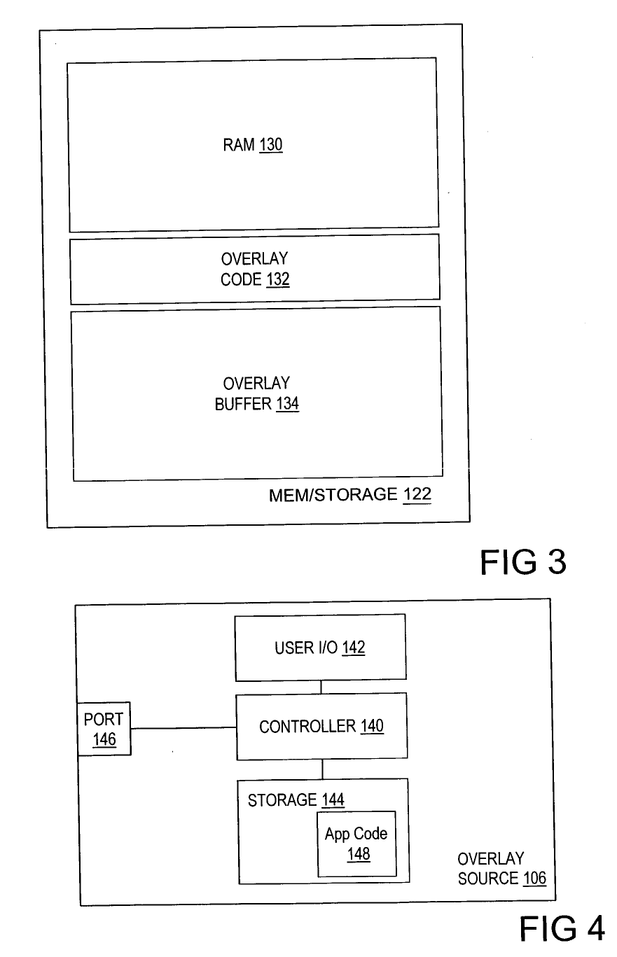

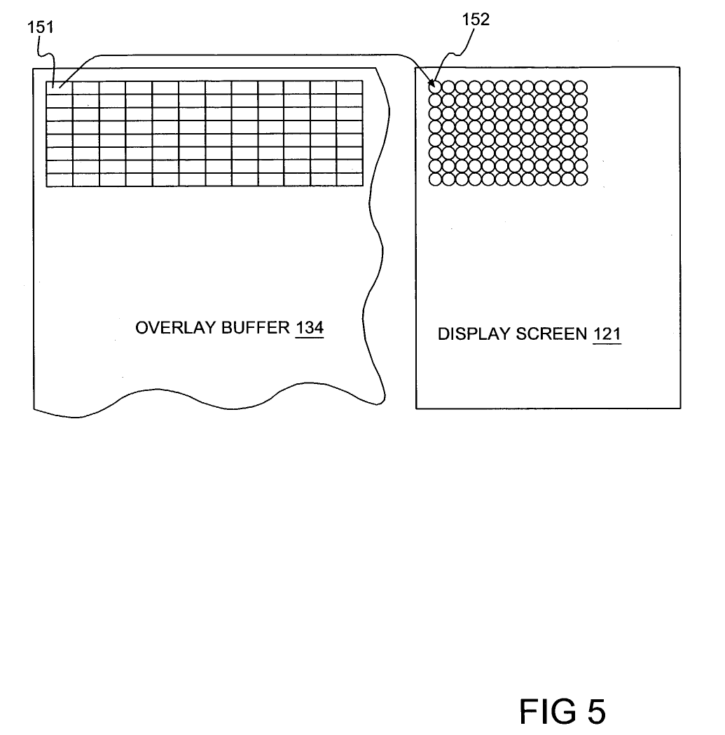

Referring now to FIG. 3 and FIG. 5, additional detail of a possible embodiment of a portion of the memory/storage facility 122 of FIG. 2 is depicted. In the depicted embodiment, memory/storage 122 includes scratch RAM 130, overlay code 132, and an overlay buffer 134. The relative sizes of the elements depicted in FIG. 3 are not intended to reflect the amount of storage dedicated to each element. Scratch RAM 130 provides working storage for controller 120 as it “renders” the overlay display 126 of FIG. 2. Overlay code 132 represents a sequence of instructions executable by controller 120. Overlay code 132 contains instructions by which controller 120 can interpret the overlay information 110 received via overlay port 107. Overlay information 110 includes content information (such as text strings or an image) that indicate the content of what the user wants to display. In some embodiments, overlay information 110 also includes attribute information that indicates what attributes the overlay image is to receive. Overlay information 110 may be formatted as a set of commands and data, perhaps compliant with an application program interface (API), that convey the content information and any attribute information to controller 120. Any such API may beneficially provide a predetermined standard definition of the format in which overlay information is to be generated by overlay source 106 and interpreted by display device 104. Overlay code 132 also includes code configured to render the overlay image in overlay buffer 134 based on overlay information 110 and code to superimpose the rendered overlay image on the display screen over the video image.

FIG. 5 illustrates an embodiment of overlay buffer 134 in which buffer 134 contains a memory cell 151 corresponding to each pixel 152 of display screen 121. In this embodiment, it is contemplated that overlay display 126 may be located over all or any portion of display screen 121. The amount of memory dedicated to the overlay facility influences its sophistication. In one embodiment, each cell 151 in overlay buffer 134 is a standard eight-bit byte needed to implement a standard 256 color scheme. If display screen 121 has, for example, 1024×1024 pixels, for a total of 1M pixels, this implementation would require an 8 Mbit overlay buffer. Additional features, such as animation or scrolling text, could be achieved at the cost of additional buffer cost.

FIG. 4 illustrates selected elements of an embodiment of the overlay source 106 of FIG. 1. In the depicted embodiment, overlay source 106 includes a controller 140 connected to user I/O facilities 142, storage 144, and a overlay source output port 146. User I/O 142 enables a user of overlay source 106 to indicate the information to be displayed as overlay information 126 (FIG. 2). In one embodiment, overlay source 106 represents a handheld data processor such as a personal digital assistant (PDA) exemplified by the Palm™ family of handheld devices from Palm, Inc. In one such embodiment, overlay source port 146 is a USB, FireWire®, or Bluetooth™ compliant port capable of communicating directly with a corresponding port of a display monitor. In this embodiment, a user of overlay source 106 program display information on a series of display monitors by connecting overlay source 106 to a single monitor, entering the desired display information such as a text string, indicating display information attributes such as position, transparency, color (both foreground and background), and any other supported attribute information. As indicated previously, the format and content of overlay information 110 may be defined by an API. In such cases, overlay source 106 includes application code 148 that provides the overlay content and attribute information in a format compliant with the API.

In a wireless implementation, the port 146 of overlay source 106 complies with a wireless standard such as Bluetooth™. Bluetooth™ ports are now commonly available on modern PDAs. This implementation may be suitable for simultaneously programming a plurality of display monitors with overlay information that is common to each display. The user of overlay source 106 could transmit the overlay information via a wireless implementation of port 146 to program multiple display devices “in parallel.” The simultaneous programming of multiple devices is also achievable in a “networked” USB or FireWire® configuration. In this embodiment, a USB or FireWire® port 146 “fans out” to the corresponding USB or FireWire® ports of multiple display monitors. The overlay information could then be transmitted to each of the connected displays using some form of broadcast or universal address.

In one embodiment suitable for use with modern television sets, overlay source 106 is implemented with the television's remote control device. In this embodiment, textual overlay information may be conveyed to the display monitor using the remote's numeric keypad in a manner similar to the manner in which alphabetic characteristics are entered on a telephone keypad. In still other embodiments, overlay source 106 and display device 104 may include common elements. In a desktop computer implementation, for example, overlay source 106 could include the computers keyboard or mouse pad with display device 104 includes the computer's monitor.

In an exemplary application of the present invention, a user provides marketing or sales information to consumers or buyers by employing the programmable overlay facility described herein. One can imagine a showroom full of television sets, computers systems, and other display monitors. A salesperson would be able to advertise promotional or other sales material to the consumer directly through the device itself. A television set, for example, could display information such as “$100 OFF TODAY ONLY” on top of the regular video image. In this manner, the invention enables a vendor of display devices to convey programmable sales and marketing information to a consumer in a most direct manner.

It will be apparent to those skilled in the art having the benefit of this disclosure that the present invention contemplates a display system suitable for enabling for providing user-defined information via a sideband signal that does not interfere with or interact with the video signal. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of displaying an image on a display device, comprising:
defining overlay information indicative of a user definable overlay image;
providing the overlay information to a second port of a display device, the display device including a first port via which a video signal is received; and
rendering the overlay image based on the overlay information and displaying the overlay image on the display screen simultaneously with a video image derived from the video signal.

2. The method of claim 1, wherein providing the overlay information to the second port comprises providing the overlay information to a USB port of the display device.

3. The method of claim 1, wherein providing the overlay information to the second port comprises providing the overlay information to a FireWire port of the display device.

4. The method of claim 1, wherein providing the overlay information to the second port comprises providing the overlay information to a Bluetooth port of the display device.

5. The method of claim 1, wherein providing the overlay information comprises providing the overlay information to a plurality of display devices.

6. The method of claim 1, wherein defining the overlay information is further characterized as defining the overlay information with a handheld, personal digital assistant.

7. The method of claim 1, wherein defining the overlay information is further characterized as defining the overlay information with a television remote control unit.

8. The method of claim 1, wherein defining the overlay information includes defining information indicative of the overlay image content and defining information indicative of attributes of the overlay image.

9. The method of claim 8, wherein defining the attribute information includes defining an attribute selected from overlay image position, overlay image transparency, and overlay image color.

10. A computer program product stored in a computer readable medium, the computer program product, comprising:
computer code means for receiving, via an overlay port of a display device, overlay information from an overlay information source device;
computer code means for rendering an overlay image based on the overlay information; and
computer code means for displaying the overlay image simultaneously with a video image derived from a video signal received via a video port.

11. The computer program product of claim 10, wherein the overlay information includes overlay content information and overlay attribute information and wherein the code means further includes code means for applying at least one attribute to the overlay information based on the overlay attribute information, wherein the at least one attribute is selected from a position of the overlay image, a transparency of the image, and a color of the image.

12. The computer program product of claim 10, further comprising code means for defining overlay information indicative of a user defined overlay image and code means for providing the overlay information to a display device.

13. The computer program product of claim 12, wherein the code means for defining overlay information includes code means for defining overlay content information indicative of the content of the overlay image and overlay attribute information indicative of the at least one attribute.

14. The computer program product of claim 10, wherein the code means for receiving the overlay information includes code means for receiving information formatted in compliance with a standard selected from a USB, FireWire, and Bluetooth.

15. A display device apparatus, comprising:
a display screen suitable for displaying images;
a controller configured to receive a video signal via a first I/O port of the display device and further configured to receive user programmable overlay information via a second I/O port of the display device; and
overlay code means for generating a user defined overlay image derived from the overlay information and for simultaneously displaying a video image derived from the video signal and the overlay image on the display screen.

16. The apparatus of claim 1, wherein the user programmable overlay information includes overlay image attribute information wherein the overlay code means applies attributes corresponding to the attribute information to the overlay image and further wherein the attribute information includes attribute information corresponding to attributes selected from a position of the overlay image on the display screen, a transparency of the overlay image, a foreground color of the overlay image, and a background color of the overlay image.

17. The apparatus of claim 15, wherein first port comprises a VGA port of a computer monitor and the second port comprises a port of the computer monitor selected from a USB port, a FireWire port, and a Bluetooth port.

18. The apparatus of claim 15, further comprising an overlay information source device comprising user I/O means and means enabling a user to define the overlay information using the I/O means and an output port suitable for conveying the overlay information to the second port of the display device.

19. The apparatus of claim 18, wherein the user programmable overlay information includes overlay image attribute information wherein the overlay code means applies attributes corresponding to the attribute information to the overlay image and further wherein the attribute information includes attribute information corresponding to attributes selected from a position of the overlay image on the display screen, a transparency of the overlay image, a foreground color of the overlay image, and a background color of the overlay image.

20. The apparatus of claim 18, wherein the source device comprises a device selected from a handheld, personal digital assistant and a television set remote control.
